(19) United States
(12) Patent Application Publication
(10) Pub. No.: US 2014/0052666 A1
(43) Pub. Date: Feb. 20, 2014

(54) SYSTEMS AND METHODS USING REAL ESTATE INVESTMENT ANALYTICS AND HEAT MAPPING

(71) Applicant: Bradley Sides, Broken Arrow, OK (US)

(72) Inventor: Bradley Sides, Broken Arrow, OK (US)

(21) Appl. No.: 13/966,227

(22) Filed: Aug. 13, 2013

Related U.S. Application Data
(60) Provisional application No. 61/682,826, filed on Aug. 14, 2012.

(51) Int. Cl. G06Q 40/06

(52) U.S. Cl. CPC G06Q 40/06
USPC 705/36 R

(57) ABSTRACT

Systems and methods using real estate investment analytics and heat mapping are provided herein. Method may include obtaining active multiple listing service (MLS) records from an MLS system that are within the target location, placing the active MLS records in a ranked list organized from a lowest price to a highest price, locating a most expensive sold property from previous MLS records, within the target location, and calculating a potential profit spread for each of the active MLS records in the ranked list in comparison with the most expensive sold property.

### CROSS REFERENCE TO RELATED APPLICATIONS

This Non-Provisional U.S. patent application claims the priority benefit of U.S. Provisional Patent Application Ser. No. 61/682,826, filed on Aug. 14, 2012, entitled “SYSTEMS AND METHODS USING REAL ESTATE INVESTMENT ANALYTICS AND HEAT MAPPING”, which is hereby incorporated by reference herein in its entirety including all references cited therein.

### FIELD OF THE INVENTION

This invention relates generally to real estate analytics, and more particularly, but not by way of limitation, to systems, methods, and media that calculate spread values for a potential real estate transactions for properties which was selected based upon territorial market segment analysis. Additionally, the present technology may generate real estate heat maps that include various territorial market segments, which are color coded.

### SUMMARY OF THE DISCLOSURE

According to an aspect of the disclosure, a system, method and computer program product are provided for calculating real estate analytics such as unique value spreads for possible real estate transactions. Additionally, present technology may generate real estate heat maps that are provided via graphical user interfaces. These heat maps provide investors with visual indices that allow for quick and easy apprehension of target locations that include suitable investment properties.

According to some embodiments, the present technology may include a method for calculating real estate analytics using a transaction analysis system comprising a processor and a memory for storing executable instructions. In some embodiments, the processor executes the instructions to perform the operations comprising: (a) receiving a target location from an end user; (b) obtaining active multiple listing service (MLS) records from an MLS system that are within the target location; (c) for each record, parsing the active MLS records to determine a price, a year built, a square footage, and a bedroom and bathroom count; (d) placing the active MLS records in a ranked list organized from a lowest price to a highest price; (e) locating a most expensive sold property from previous MLS records, within the target location; (f) comparing a square footage, a year built, a square footage, and a bedroom and bathroom count of the most expensive sold property to each of the active MLS records in the ranked list; (g) calculating a potential profit spread for each of the active MLS records in the ranked list; and (h) outputting for display a potential profit spread list that includes the potential profit spread for each of the active MLS records in the ranked list.

According to some embodiments, the present technology may include a transaction processing system, comprising: (a) a processor; and (b) a memory for storing executable instructions that comprise: (i) a user interface module providing a user interface for receiving a target location; (ii) an MLS record parsing module that: (1) obtains active multiple listing service (MLS) records from an MLS system, via a communications interface, that are within the target location; and (2) for each record, parsing the active MLS records to determine a price, a year built, a square footage, and a bedroom and bathroom count; (iii) a transaction analysis module that: (3) places the active MLS records in a ranked list organized from a lowest price to a highest price; (4) locates a most expensive sold property from previous MLS records, within the target location; (5) compares a square footage, a year built, a square footage, and a bedroom and bathroom count of the most expensive sold property to each of the active MLS records in the ranked list; (6) calculates a potential profit spread for each of the active MLS records in the ranked list; and (iv) wherein the user interface module further outputs for display a potential profit spread list that includes the potential profit spread for each of the active MLS records in the ranked list.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced.

FIG. 1 illustrates an exemplary architecture for practicing aspects of the present technology;

FIG. 2 is a schematic diagram of an exemplary transactional analysis system, constructed in accordance with the present technology;

FIG. 3 is a flowchart of an exemplary method for calculating real estate analytics;

FIG. 4 is a flowchart of an exemplary method for generating a real estate heat map; and

FIG. 5 is a graphical user interface in the form of a heat map illustrating a plurality of segments; and

FIG. 6 illustrates an exemplary computing system that may be used to implement embodiments according to the present technology.

### DETAILED DESCRIPTION OF EXEMPLARY EMBODIMENTS

In the following description, for purposes of explanation, numerous specific details are set forth in order to provide a thorough understanding of the disclosure. It will be apparent, however, to one skilled in the art, that the disclosure may be practiced without these specific details. In other instances, structures and devices are shown at block diagram form only in order to avoid obscuring the disclosure.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is noted at the outset that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purpose only, and are not drawn to scale.

According to some embodiments, the present technology may be configured to apply unique algorithms to calculate spreads used by investors to evaluate the potential value in a piece of real estate.

Additionally, the present technology generates real estate heat maps that provide investors with a means for quantifying potential real estate investment opportunities in terms of geographical location, using other various property characteristics.

The aforementioned features of the present technology are executed within a web-based server architecture, such as a cloud, or other similar computing device, the details of which will be described in greater detail below.

An exemplary server of the present technology may comprise executable instructions that are stored the memory of the server. Furthermore, these executable instructions may be executed by one or more processors of the server to perform one or more of the following methods.

With regard to generating real estate heat maps, an end user may input a selected location in which they are interested in locating investment properties. Exemplary locations include an arbitrary market such a city, neighborhood, or subdivision—just to name a few. The server may apply one or more business rules to locate suitable market segments that comply with the rules. For example, the system may consider, for each property within the selected location, school district, crime statistics, days on the market, and/or other attributes for the properties. The relative importance or weight placed upon each of the attributes may affect the visual appearance and composition of the heat map. Thus, an investor may be more concerned with school district and crime statistics and may weight these two features more heavily in the calculation.

The server may pull data from various third party resources for each of the desired attributes. For example, the server may locate crime statistics from a local police department database.

Thus the rules not only include weightings per category, but also threshold values that allow the system to rank properties. For example, a rule may include a threshold value of “less than ten larcenies per year” for crime.

When the rules are applied to the selected location, groupings of properties that meet the established requirements may be determined. Additionally, properties that do not meet the established requirements are also determined. Moreover, the degree of matching between a property and the rules may be quantified and used to rank properties relative to one another.

The system may also use thresholds for grouping properties according to rank. For example, properties that are ranked and fall between 90% and 100% of a closeness of fit to the rules may be grouped together.

According to some embodiments, once a ranking has been determined for each property, the system may employ a location-based comparison of properties to establish territorial market segments within the selected location that include more than one property. For example, only properties that are within a distance value of one mile from one another may be considered to be within a territorial market segment. The distance value may include any value, but in some instances, the distance value may be established by local rules used by appraisers. In some instances, undesirable market segments may also be identified.

The system may then use the aforementioned market segments, both desirable and undesirable, to generate a heat map that provides the investor with a visual guide to their selected location. Using a base map image of the selected location, desirable territorial market segments may be overlaid onto the map and outlined or colored with a distinctive hue, for example green. Undesirable territorial market segments may be overlaid onto the map and colored with a distinctive hue, for example orange. Very undesirable territorial market segments may be colored red.

Thus, the investor may use the real estate heat map to quickly and easily identify desirable territorial market segments that include properties that fit within the various rules established by the investor.

Using the desirable territorial market segments, the system may obtain multiple listing service (“MLS”) data for each active (e.g., currently on the market) property in the desirable territorial market segment. Next, the system may obtain MLS data on sold properties in the desirable territorial market segment that were sold within a given period of time.

The system may extract thirteen unique data points for each of the active and sold properties from an examination of the MLS data. The system may then rank each of the properties in top-down order starting with least expensive to most expensive. Next, the system will locate the most expensive sold property and execute a one-to one comparison between the thirteen data points of the most expensive sold property and each of the active properties, starting with the least expensive active property and iterating through each active listing.

After property comparisons have been made, the system may apply weighting factors to one or more of the thirteen unique data point pairs (e.g., square footage of an active property compared to the square footage of the most expensive sold property).

In some embodiments, square footage may be weighted more highly in the calculation than garage size. In some instances age, square footage, beds/baths, and price may be weighted heavily. Active properties that are discrepant to the most expensive sold property in one or more of these attributes may be eliminated from further consideration. For example, an active property that is more than five years old and has more than 500 square feet less than the most expensive sold property may be eliminated. Thus, the active property list may be initially culled based upon these comparisons.

Additionally, the thirteen unique data points the most expensive sold property may be used to calculate a spread value for each suitable active property. By way of non-limiting example, assume that the most expensive sold property had a value of $150,000, three beds, two baths, was constructed in 1995, and had a square footage of 1,500. The least expensive active property that survived the initial matching has a value of $120,000, 3 beds, and two baths, which was constructed in 1996, an included a square footage of 1,650. Calculating a price per square foot for the most expensive sold property of $100, one could expect to sell the least expensive active property listed for $165,000, for a potential spread of $45,000. While calculating spread values for properties is known, the combination of the spread score, calculated relative to active and sold properties that fall within uniquely calculated territorial market segments provides unique benefits. Moreover, the weighting of very specific data points provides advantages over existing technology.

Using the spread scores, the system may generate a ranked list of active properties that are output to the investor. In other instances, the ranked list of active properties may be overlaid upon the heat map generated above.

According to some embodiments, the present technology may place the active properties into profit margin bands based upon their respective spread scores, relative to their selling price. For example, properties having a value of from $100,000 to $200,000 would need a spread of at least $40,000, and properties having a value of from $200,000 to $300,000 would need a spread of at least $60,000. These profit margin bands may be used to quickly categorize active properties based upon their calculated spread. The profit margin bands are established based upon analytical information such as average rehabilitation costs and the like.

Finally, the system may further evaluate suitable active properties with sufficient spread scores using data such as traffic counts, excessive days on market, high local vacancies (rent or lease), walk scores, and so forth.

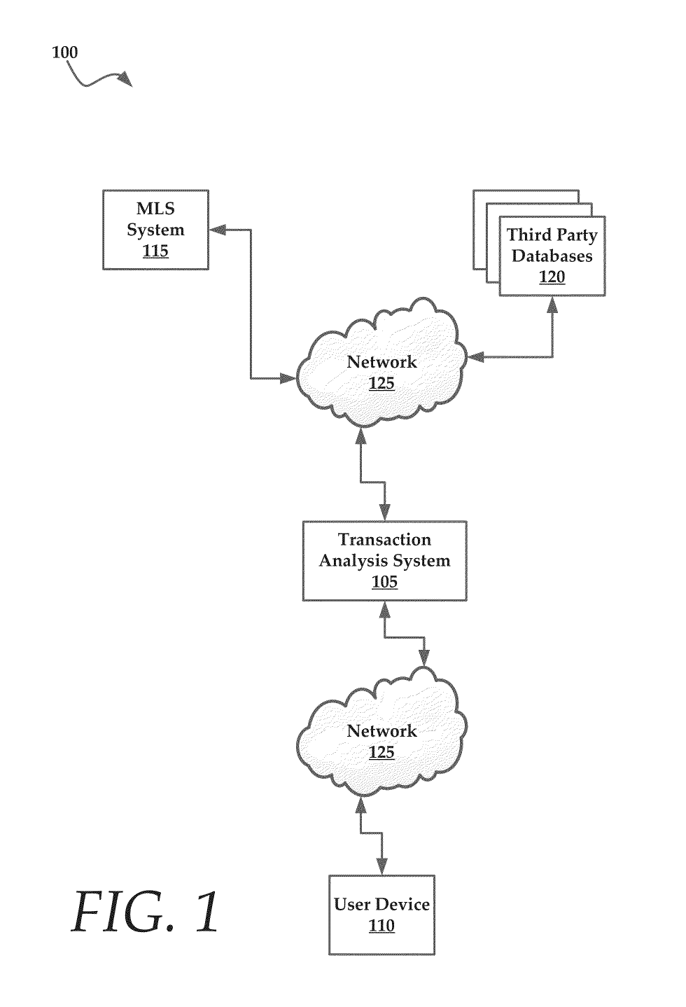

FIG. 1 illustrates an exemplary architecture 100 for practicing aspects of the present technology. The architecture 100 may include a transaction analysis system (hereinafter system 105), a user device 110, an MLS system 115, and various third party databases 120. The various components of the architecture 100 may be communicatively coupled via a network 125.

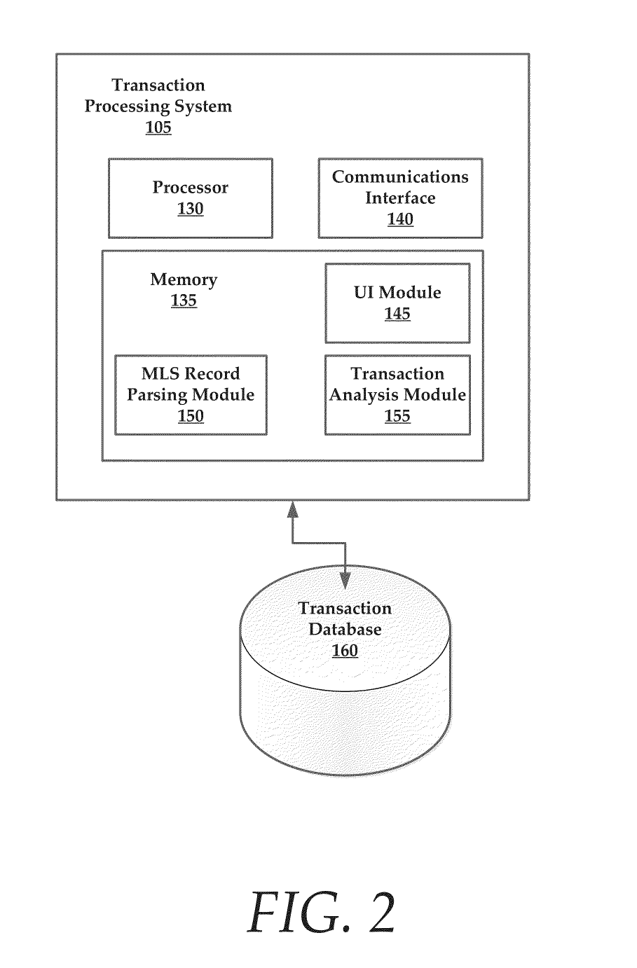

In some embodiments, end users may utilize an end user device 110 to interact with the system 105. In some instances, the system 105 may generate graphical user interfaces that allow users to interface with the system 105 using, for example, a web browser client. A more detailed description of the system 105 is provided below with reference to FIG. 2.

In some instances, the system 105 may obtain MLS records from the MLS system 115. Also, the system 105 may obtain other descriptive information about an MLS record from one or more third party databases 120. That is, while MLS records may include descriptive information that is used by the system 105, the system 105 may also utilize descriptive information that may not be included in a typical MLS record. For example, while an MLS record may include a list price, a square footage, a bedroom or bathroom count, and the like, the MLS record for a property may not include other information such as local traffic data, local demographics, property volumes, and so forth. These ancillary types of information may be obtained from a third party database. By way of example, traffic data may be utilized to determine whether a property is on a busy street. To determine such information, the system 105 may consult a third party database of traffic information.

Turning to FIG. 2, in some instances, the system 105 may include a processor 130 and a memory 135 for storing executable instructions. Also the system 105 may include a communications interface 140 that allows the system 105 to communicatively couple with the user device 110, the MLS system 115, and third party databases 120.

According to some embodiments, the memory 135 includes a UI module 145, a MLS record parsing module 150, and a transaction analysis module 155.

The processor 130 of the system 105 may execute the user interface module 145 to provide a user interface for receiving a target location. An end user may specify a desired or target location where they desire to locate potential real estate transactions.

In general, an end user may utilize the system 105 to obtain a list of available properties that are currently available for purchase. This list preferably includes a ranking of available properties that have a relatively high potential profit margin. The details of determining this list will be provided in greater detail below.

In some instances, the processor 130 executes the MLS record parsing module 150 to obtain all active MLS records within the specified target location. In some instances, the system 105 may obtain active listings that are outside the target location if no, or a relatively low amount, active listings are found in the target location. The proximity for this extended boundary may be bound by factors such as zip code, school district boundaries, neighborhood boundaries, and the like. Thus, while the target location can be expanded beyond the location specified by the user, the system 105 may advantageously limit this proximity to locations that are likely to include active listings that are comparable to recent sold listings in the target location.

Once active MLS records are obtained, the system 105 may, for each MLS record, determine a price, a year built, a square footage, and a bedroom and bathroom count. Other metrics can be determined such as a location, a status, an MLS number, a subdivision, a list price, a days on the market value, and a school district.

In some instances, the system 105 may assign a weight to various attributes. For example, price, year built, square footage, bedroom and bathroom count may be weighted more highly than subdivision, days on the market, and so forth. The weighting may include applying a weighting coefficient. For example, in a calculation of the spread, a days on the market metric may allow for subtraction of a certain monetary amount for each extra day on the market above 30 days. If days on the market are not an important metric for the investor, the amount of value subtracted may be reduced by multiplying the amount with a weighting factor. For example, if the days on the market were 45 and the system 105 were specified to remove $500 per day over a threshold of 30 days, but this metric were unimportant for the investor, the system 105 may multiply this value against a coefficient of 0.15 to reduce the amount to 15% of the total amount. Other metrics may likewise be adjusted.

Once the information has been parsed from the active MLS records, the processor 130 of the system 105 may execute the transaction analysis module 155 to place the active MLS records in a ranked list organized from a lowest price to a highest price. After generating the ranked list, the transaction analysis module 155 may consult historical MLS data and locate a most expensive sold property from previous MLS records, within the target location. More specifically, the most expensive sold property located by the transaction analysis module 155 includes a property that has been sold within the target location within a set period of time. This set period of time may vary according to market conditions. For example, if the system 105 determines from historical MLS data that properties are selling quickly relative to the previous two years, the system 105 may set the period of time to six months. In other instances, if properties are selling in the target location according to historical averages, the system 105 may set the period of time to one year or 18 months. In some instances, the period of time may be defined by the end user.

In some instances, the transactional analysis module 155 may be configured to compare at least a square footage, a year built, a square footage, and a bedroom and bathroom count of the most expensive sold property to each of the active MLS records in the ranked list. In some instances, the comparison may include a comparison on the aforementioned attributes of the properties, but may also include metrics such as a location, a status (active, pending, etc.), an MLS number, a subdivision, a list price, a days on the market value, and a school district.

In some instances, the transaction analysis module 155 may automatically eliminate certain active MLS records. For example, the transaction analysis module 155 may automatically eliminate active MLS records from comparison that are located on a busy street as determined by evaluating historical traffic data in the target location. In other instances, the transaction analysis module 155 may automatically eliminate active MLS records that have a year built that is greater than an established year built threshold. For example, properties that were built earlier than five years than the most expensive sold property may be eliminated.

In some instances, the transaction analysis module 155 may automatically eliminate active MLS records that have a square footage that is outside of an acceptable square footage range. Also, the transaction analysis module 155 may automatically eliminate active MLS records that have a days on the market that is greater than an established DOM threshold.

According to some embodiments, the transaction analysis module 155 may automatically eliminate active MLS records for sub-segments of the target location having high vacancy rates, as well as active MLS records for sub-segments of the target location having a high volume of available properties.

It will be understood that a sub-segment of a target location may include, for example, a street or another section or sector of a target location. For example, if a target location is a zip code of a city, a target location may include neighborhoods within the zip code. Another exemplary target location may include a school district, where a sub-segment may include a set of streets.

It will also be understood that the various thresholds described above may be end user-defined. Also, the thresholds may be established from an analysis of historical property sales and MLS records.

After culling the active MLS records that do not correspond to the most expensive sold property in the target location, the transaction analysis module 155 may calculate a potential profit spread for each of the active MLS records in the ranked list.

In some embodiments, the UI module 140 may output for display a potential profit spread list that includes the potential profit spread for each of the active MLS records in the ranked list. The ranked list may be stored in a transaction database 160 for later retrieval.

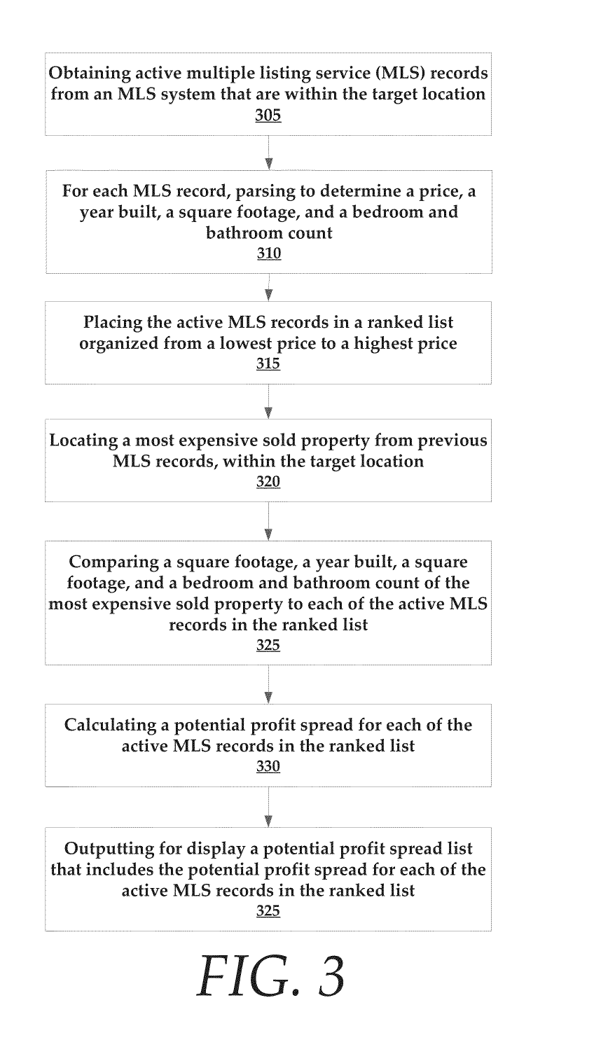

FIG. 3 is a flowchart of an exemplary method for calculating real estate analytics using a transaction analysis system. The method includes obtaining 305 active multiple listing service (MLS) records from an MLS system that are within the target location. The method also includes, for each record, parsing 310 to determine a price, a year built, a square footage, and a bedroom and bathroom count.

Next, the method includes placing 315 the active MLS records in a ranked list organized from a lowest price to a highest price, as well as locating 320 a most expensive sold property from previous MLS records, within the target location.

Also, the method includes comparing 325 a square footage, a year built, a square footage, and a bedroom and bathroom count of the most expensive sold property to each of the active MLS records in the ranked list. For active MLS records that are comparable to the most expensive sold property, the method includes calculating 330 a potential profit spread for each of the active MLS records in the ranked list.

Finally, the method includes outputting 335 for display a potential profit spread list that includes the potential profit spread for each of the active MLS records in the ranked list. In some instances, the profit spread list may be stored in a transactional database.

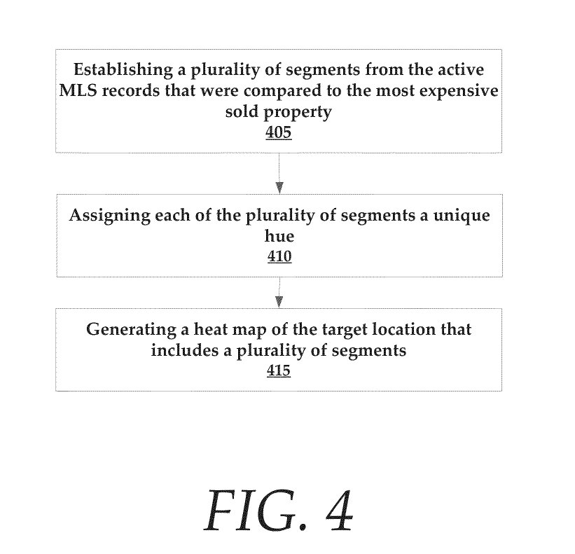

FIG. 4 illustrates an exemplary method for generating a heat map. The method includes establishing 405 a plurality of segments from the active MLS records that were compared to the most expensive sold property. Furthermore, these active MLS records have been culled to remove MLS records that did not correspond or compare to the most expensive property sold.

It will be understood that each of the plurality of segments includes active MLS records that are grouped based upon their potential profit spreads. For example, active MLS records that include a potential profit spread from $10,000 to $25,000 are assigned a hue of blue, while active MLS records that include a potential profit spread from $25,000 to $50,000 are assigned a hue of yellow, and active MLS records that include a potential profit spread from $50,000 to $75,000 are assigned a hue of green. Other segments and hues may likewise be utilized in accordance with the present technology.

Next, the method includes assigning 410 each of the plurality of segments a unique hue. The unique hue for a segment is based upon the potential profit spreads for the active MLS listings included in each of the plurality of segments. Also, the method includes generating 415 a heat map of the target location that includes a plurality of segments. The plurality of segments on the heat may be visually distinguished due to the coloring of each of the plurality of segments with a unique hue.

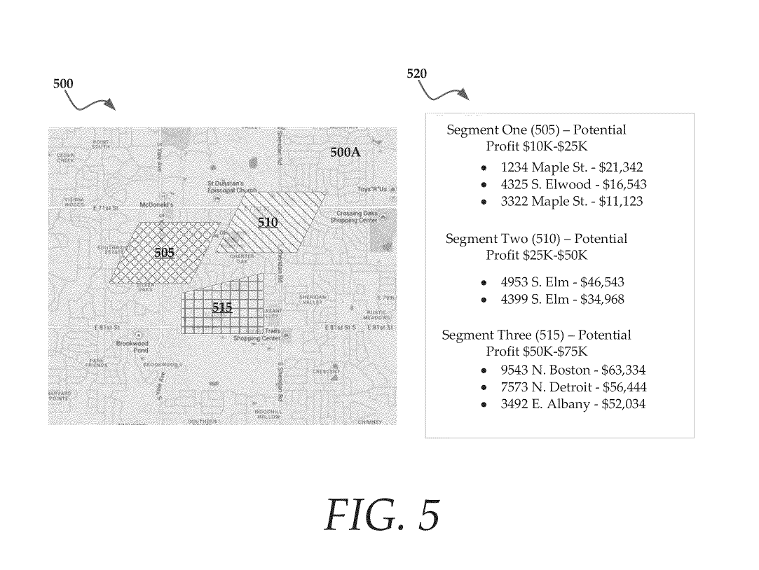

FIG. 5 is a graphical user interface that includes a heat map 500. The heat map 500 includes an exemplary map layer that includes a target location 500A. Within the target location 500A, a plurality of segments are provided, such as segment 505, segment 510, and segment 515. In some instances, these segments include active MLS listings that fall within potential profit bands. For example, segment 505 includes active MLS records that fall within a potential profit range of $10,000 to $25,000. Segment 510 includes active MLS records that fall within a potential profit range of $25,000 to $50,000, and segment 515 includes active MLS records that fall within a potential profit range of $50,000 to $75,000.

In some instances, each of the segments will be provided with a hue. For example, segment 505 is provided with a hue of blue, segment 510 is provided with a hue of yellow, and segment 515 is provided with a hue of green. These various hues have been illustrated as patterns on the heat map 500.

Also, a UI 520 may be displayed that includes active MLS records within each of the segments 505-515. Each of the segments includes a ranked list of active MLS records that are ranked according to their calculated potential profit, in light of the most expensive sold property within the target location 500A.

A “computer”, as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a super computer, a personal computer, a laptop computer, a palmtop computer, a notebook computer, a desktop computer, a workstation computer, a server, or the like, or an array of processors, microprocessors, central processing units, general purpose computers, super computers, personal computers, laptop computers, palmtop computers, notebook computers, desktop computers, workstation computers, servers, or the like.

A “server”, as used in this disclosure, means any combination of software and/or hardware, including at least one application and/or at least one computer to perform services for connected clients as part of a client-server architecture. The at least one server application may include, but is not limited to, for example, an application program that can accept connections to service requests from clients by sending back responses to the clients. The server may be configured to run the at least one application, often under heavy workloads, unattended, for extended periods of time with minimal human direction. The server may include a plurality of computers configured, with the at least one application being divided among the computers depending upon the workload. For example, under light loading, the at least one application can run on a single computer. However, under heavy loading, multiple computers may be required to run the at least one application. The server, or any if its computers, may also be used as a workstation.

A “database”, as used in this disclosure, means any combination of software and/or hardware, including at least one application and/or at least one computer. The database may include a structured collection of records or data organized according to a database model, such as, for example, but not limited to at least one of a relational model, a hierarchical model, a network model or the like. The database may include a database management system application (DBMS) as is known in the art. The at least one application may include, but is not limited to, for example, an application program that can accept connections to service requests from clients by sending back responses to the clients. The database may be configured to run the at least one application, often under heavy workloads, unattended, for extended periods of time with minimal human direction.

A “communication link”, as used in this disclosure, means a wired and/or wireless medium that conveys data or information between at least two points. The wired or wireless medium may include, for example, a metallic conductor link, a radio frequency (RF) communication link, an Infrared (IR) communication link, an optical communication link, or the like, without limitation. The RF communication link may include, for example, WiFi, WiMAX, IEEE 802.11, DECT, OG, 1G, 2G, 3G or 4G cellular standards, Bluetooth, and the like.

A “network,” as used in this disclosure means, but is not limited to, for example, at least one of a local area network (LAN), a wide area network (WAN), a metropolitan area network (MAN), a personal area network (PAN), a campus area network, a corporate area network, a global area network (GAN), a broadband area network (BAN), a cellular network, the Internet, or the like, or any combination of the foregoing, any of which may be configured to communicate data via a wireless and/or a wired communication medium. These networks may run a variety of protocols not limited to TCP/IP, IRC or HTTP.

The terms “including”, “comprising” and variations thereof, as used in this disclosure, mean “including, but not limited to”, unless expressly specified otherwise. The terms “a”, “an”, and “the”, as used in this disclosure, means “one or more”, unless expressly specified otherwise. Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices, which are not explicitly described as having such functionality or features.

A “computer-readable medium”, as used in this disclosure, means any medium that participates in providing data (for example, instructions), which may be read by a computer. Such a medium may take many forms, including non-volatile media, volatile media, and transmission media. Non-volatile media may include, for example, optical or magnetic disks and other persistent memory. Volatile media may include dynamic random access memory (DRAM). Transmission media may include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read. The computer-readable medium may include a “Cloud,” which includes a distribution of files across multiple (e.g., thousands of) memory caches on multiple (e.g., thousands of) computers.

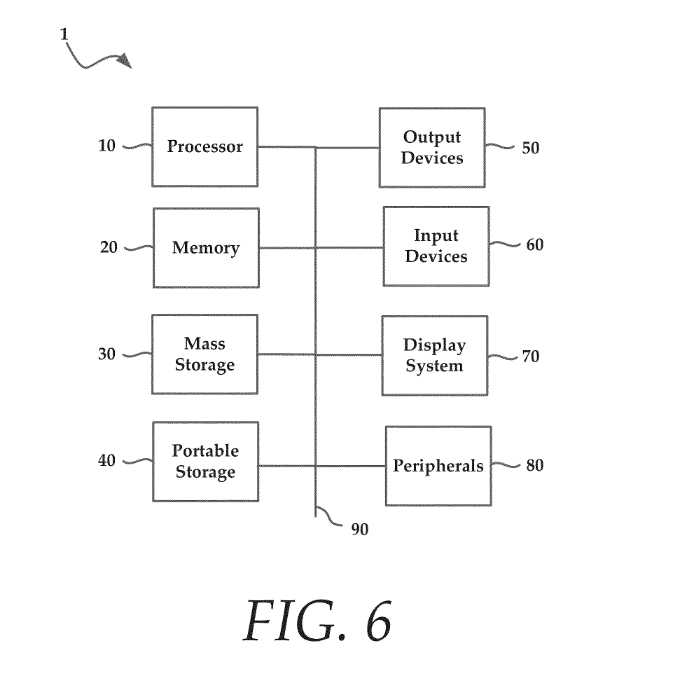

FIG. 6 illustrates an exemplary computing device 1 that may be used to implement an embodiment of the present systems and methods. The system 1 of FIG. 6 may be implemented in the contexts of the likes of computing devices, network nodes, servers, or combinations thereof. The computing device 1 of FIG. 6 includes a processor 10 and main memory 20. Main memory 20 stores, in part, instructions and data for execution by processor 10. Main memory 20 may store the executable code when in operation. The system 1 of FIG. 6 further includes a mass storage device 30, portable storage device 40, output devices 5, user input devices 60, a display system 70, and peripherals 80.

The components shown in FIG. 6 are depicted as being connected via a single bus 90. The components may be connected through one or more data transport means. Processor 10 and main memory 20 may be connected via a local microprocessor bus, and the mass storage device 30, peripherals 80, portable storage device 40, and display system 70 may be connected via one or more input/output (I/O) buses.

Mass storage device 30, which may be implemented with a magnetic disk drive or an optical disk drive, is a non-volatile storage device for storing data and instructions for use by processor 10. Mass storage device 30 can store the system software for implementing embodiments of the present technology for purposes of loading that software into main memory 20.

Portable storage device 40 operates in conjunction with a portable non-volatile storage medium, such as a floppy disk, compact disk or digital video disc, to input and output data and code to and from the computing system 1 of FIG. 6. The system software for implementing embodiments of the present technology may be stored on such a portable medium and input to the computing system 1 via the portable storage device 40.

Input devices 60 provide a portion of a user interface. Input devices 60 may include an alphanumeric keypad, such as a keyboard, for inputting alphanumeric and other information, or a pointing device, such as a mouse, a trackball, stylus, or cursor direction keys. Additionally, the system 1 as shown in FIG. 6 includes output devices 50. Suitable output devices include speakers, printers, network interfaces, and monitors.

Display system 70 may include a liquid crystal display (LCD) or other suitable display device. Display system 70 receives textual and graphical information, and processes the information for output to the display device.

Peripherals 80 may include any type of computer support device to add additional functionality to the computing system. Peripherals 80 may include a modem or a router.

The components contained in the computing system 1 of FIG. 6 are those typically found in computing systems that may be suitable for use with embodiments of the present technology and are intended to represent a broad category of such computer components that are well known in the art. Thus, the computing system 1 can be a personal computer, hand held computing system, telephone, mobile computing system, workstation, server, minicomputer, mainframe computer, or any other computing system. The computer can also include different bus configurations, networked platforms, multi-processor platforms, etc. Various operating systems can be used including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the technology. Those skilled in the art are familiar with instructions, processor(s), and storage media.

Computer program code for carrying out operations for aspects of the present technology may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

Aspects of the present technology are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

What is claimed is:

1. A method for calculating real estate analytics using a transaction analysis system comprising a processor and a memory for storing executable instructions, wherein the processor executes the instructions stored in memory to perform the method, comprising:
receiving a target location from an end user;
obtaining active multiple listing service (MLS) records from an MLS system that are within the target location;
for each record, parsing to determine a price, a year built, a square footage, and a bedroom and bathroom count;
placing the active MLS records in a ranked list organized from a lowest price to a highest price;
locating a most expensive sold property from previous MLS records, within the target location;
comparing a square footage, a year built, a square footage, and a bedroom and bathroom count of the most expensive sold property to each of the active MLS records in the ranked list;
calculating a potential profit spread for each of the active MLS records in the ranked list; and
outputting for display a potential profit spread list that includes the potential profit spread for each of the active MLS records in the ranked list.

2. The method according to claim 1, wherein comparing further comprises comparing a location, a status, an MLS number, a subdivision, a list price, a days on the market value, and a school district.

3. The method according to claim 1, further comprising:
calculating a percentage of sold price per percentage of list price value for a plurality of properties sold in the target location; and
calculating a list price for each active MLS record in the ranked list to the percentage of sold price per percentage of list price values.

4. The method according to claim 1, wherein the active MLS records selected from the MLS system are obtained from a proximity extending around the target location.

5. The method according to claim 1, further comprising eliminating from the comparison any of:
active MLS records from comparison that are located on a busy street as determined by evaluating historical traffic data in the target location;
active MLS records that have a year built that is greater than an established year built threshold;
active MLS records that have a square footage that is outside of an acceptable square footage range;
active MLS records that have a days on the market that is greater than an established DOM threshold;
active MLS records for sub-segments of the target location having high vacancy rates; and
active MLS records for sub-segments of the target location having a high volume of available properties.

6. The method according to claim 1, further comprising:
establishing profit margin bands, wherein each of the profit margin bands includes a range of profit margins; and
placing each of the active MLS records in one of the profit margin bands based upon the profit spread calculated for each of the active MLS records.

7. The method according to claim 1, further comprising:
establishing a plurality of segments, wherein each of the plurality of segments includes active MLS records that are grouped based upon their potential profit spreads;
assigning each of the plurality of segments a unique hue, further wherein the unique hue is based upon the potential profit spreads for the active MLS records included in each of the plurality of segments; and
generating a heat map of the target location that includes a plurality of segments, wherein each of the plurality of segments is provided with a unique hue.

8. A transaction processing system, comprising:
a processor; and
a memory for storing executable instructions that comprise:
a user interface module providing a user interface for receiving a target location;
an MLS record parsing module that:
obtains active multiple listing service (MLS) records from an MLS system, via a communications interface, that are within the target location; and
for each record, parses to determine a price, a year built, a square footage, and a bedroom and bathroom count;
a transaction analysis module that:
places the active MLS records in a ranked list organized from a lowest price to a highest price;
locates a most expensive sold property from previous MLS records, within the target location;
compares a square footage, a year built, a square footage, and a bedroom and bathroom count of the most expensive sold property to each of the active MLS records in the ranked list;
calculates a potential profit spread for each of the active MLS records in the ranked list; and
wherein the user interface module further outputs for display a potential profit spread list that includes the potential profit spread for each of the active MLS records in the ranked list.

9. The system according to claim 8, wherein the transaction analysis module further compares a location, a status, an MLS number, a subdivision, a list price, a days on the market value, and a school district for each active MLS record to a location, a status, an MLS number, a subdivision, a list price, a days on the market value, and a school district for the most expensive sold property.

10. The system according to claim 8, wherein the transaction analysis module further:
calculates a percentage of sold price per percentage of list price value for a plurality of properties sold in the target location; and
calculates a list price for each active MLS record in the ranked list to the percentage of sold price per percentage of list price values.

11. The system according to claim 8, wherein the active MLS records selected from the MLS system are obtained from a proximity extending around the target location.

12. The system according to claim 8, wherein the transaction analysis module is further configured to eliminate from the comparison any of:
active MLS records from comparison that are located on a busy street as determined by evaluating historical traffic data in the target location;
active MLS records that have a year built that is greater than an established year built threshold;
active MLS records that have a square footage that is outside of an acceptable square footage range;

13. The system according to claim 12, wherein the transaction analysis module is further configured to eliminate from the comparison any of:
active MLS records that have a days on the market that is greater than an established DOM threshold;
active MLS records for sub-segments of the target location having high vacancy rates; and
active MLS records for sub-segments of the target location having a high volume of available properties.

14. The system according to claim 8, wherein the transaction analysis module is further configured to:
establish profit margin bands, wherein each of the profit margin bands includes a range of profit margins; and
place each of the active MLS records in one of the profit margin bands based upon the profit spread calculated for each of the active MLS records.

15. The system according to claim 8, wherein the user interface module is further configured to generate a heat map of the target location that includes a plurality of segments, wherein each of the plurality of segments is provided with a unique hue, further wherein the unique hue is based upon the potential profit spreads for MLS listings included in each of the plurality of segments as calculated by the transaction analysis module.

16. The system according to claim 8, wherein the most expensive sold property located by the transaction analysis module includes a property that has been sold within the target location within a set period of time.
